(19) United States
(12) Patent Application Publication
(10) Pub. No.: US 2026/0100001 A1
(43) Pub. Date: Apr. 9, 2026

(54) EXTENDED REALITY UNDERSTANDING THROUGH MULTIMODAL CONSTRAINED DECODING

(71) Applicants: Kwot Sin Lee, Weehawken, NJ (US); Maksim Gusarov, Santa Monica, CA (US)

(72) Inventors: Kwot Sin Lee, Weehawken, NJ (US); Maksim Gusarov, Santa Monica, CA (US)

(21) Appl. No.: 18/908,955

(22) Filed: Oct. 8, 2024

(51) Int. Cl. G06T 19/00; G06V 20/70; G06V 30/10

(52) U.S. Cl. CPC G06T 19/006; G06V 20/70; G06V 30/10

(57) ABSTRACT

Examples relate to processing extended reality (XR) content. A system obtains an unmodified image and a modified image with an XR effect applied. A trained multimodal generative language model generates visual difference text describing differences between the images. Additional text data associated with the XR effect is obtained. The additional text data can include visual text displayed by the XR effect and/or metadata associated with the XR effect. A trained generative language model processes the visual difference text and additional text data to generate output text data descriptive of the XR effect. The output text data may include content tags, location information, and a merged caption. Constrained decoding ensures the output adheres to a predefined structure. The system enables automated understanding and categorization of XR effects for applications like content discovery, recommendations, and moderation.

### TECHNICAL FIELD

The present disclosures relate to extended reality (XR) technologies and, in some examples, to algorithms and systems to analyze and categorize XR experiences using multimodal constrained decoding.

### BACKGROUND

A head-worn device may be implemented with a transparent or semi-transparent display through which a user of the device can view the surrounding environment. Such devices enable a user to see through the transparent or semi-transparent display to view the surrounding environment, and to also see objects or other content (e.g., virtual objects such as 3D renderings, images, video, text, and so forth) that are generated for display to appear as a part of, and/or overlaid upon, the surrounding environment (referred to collectively as “virtual content”). In some cases, the display is opaque, and the user is presented with a visual representation of the real-world environment as captured by cameras on the device; this approach can also be implemented by mobile devices such as smart phones. Each of these approaches is typically referred to as “extended reality” or “XR”, which encompasses techniques such as augmented reality (AR), virtual reality (VR), and mixed reality (MR). Each of these technologies combines aspects of the physical world with virtual content presented to a user.

### BRIEF DESCRIPTION OF THE SEVERAL VIEWS OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some non-limiting examples are illustrated in the figures of the accompanying drawings in which:

FIG. 1 is a block diagram illustrating a system for processing extended reality (XR) content, according to some examples.

FIG. 2 is a flowchart illustrating an example method for generating standardized text data characterizing an XR effect, according to some examples.

FIG. 3 is a collage illustrating a first example of an unmodified frame and a modified frame with an XR effect applied, according to some examples.

FIG. 4 is a collage illustrating a second example of an unmodified frame and a modified frame with an XR effect applied, according to some examples.

FIG. 5 is a collage illustrating a third example of an unmodified frame and a modified frame with an XR effect applied, including text in a non-English language, according to some examples.

FIG. 6 is a diagrammatic representation of a machine in the form of a computer system within which a set of instructions may be executed to cause the machine to perform any one or more of the methodologies discussed herein, according to some examples.

FIG. 7 is a block diagram showing a software architecture within which examples may be implemented.

FIG. 8 illustrates a machine-learning pipeline, according to some examples.

FIG. 9 illustrates training and use of a machine-learning program, according to some examples.

### DETAILED DESCRIPTION

Examples described herein relate to techniques for understanding and processing extended reality (XR) content. These techniques aim to address challenges in analyzing and categorizing XR effects in a way that is useful for production systems.

The field of XR content production struggles with the unsolved technical problem of how to automatically characterize and categorize XR effects and virtual content. While Multimodal Large Language Models (MLLMs) can generate captions for XR effects, the MLLM caption outputs are not directly usable in production systems. Production systems typically require fixed, parsable outputs, whereas the MLLM-generated captions are typically freeform and non-standardized. Additionally, there is sometimes additional information about the XR content that is made available after the MLLM has been trained, which the MLLM cannot directly utilize.

To address these issues, examples described herein provide a post-processing system that combines multiple sources of information and uses constrained decoding to generate structured, usable outputs. In some examples, the system includes several components that work together to process and understand XR content. First, a data processing component can be used to extract frames from rendered XR effect videos and corresponding base videos. It uses a rendering detection method to identify the most relevant pair of rendered and base frames. This process creates collages that capture the before-and-after effect of the XR content. Second, a model training component can be used to a model, such as a BLIP2 (Bootstrapping Language-Image Pre-training 2) model, which is a type of MLLM. The model is fine-tuned using a technique called LoRA (Low-Rank Adaptation) to focus on describing the XR effects rather than the underlying content. The training process uses cleaned, human-annotated descriptions of XR effects. Third, a model inference component can be used to operate the trained model. Once trained, the BLIP2 model generates captions for new XR effects. The inference process is optimized for efficiency, using techniques for streaming data such as web dataset .tar files. Fourth, an OCR text extraction component uses optical character recognition (OCR) to extract text from the rendered frames. The OCR pipeline can be configured to detect text in multiple written languages, such as English characters and Arabic script. The system may use high-resolution rendered frames for this process to ensure accurate text detection. Fifth, a translation component can be used to translate non-primary language content into the primary language used by the system's language model. Because the OCR pipeline can detect text in multiple languages, but the system's Large Language Model (LLM) may primarily understand a primary language (such as English), a translation step can be included. Any suitable translation tool, such as the Google Translate® API, can be used to translate (for example) non-English text to English. Sixth, a post-processing component of the system can use an LLM, such as Mistral-7B, to combine information from multiple sources: the BLIP2 captions, the XR effect title, and the OCR text. The LLM performs constrained decoding, which means it outputs a fixed schema that can be parsed into a standardized format, such as a JavaScript Object Notation (JSON) format.

In some examples, the constrained decoding process uses a finite state machine approach for token-level decoding. This ensures that the output adheres to a specific structure. The LLM is instructed to produce three types of textual data: (a) Content tags based on the captions and metadata, (b) Location text describing where the XR effects are applied, and (c) A merged caption that combines the textual information from (a) and (b). In some examples, the system uses in-context examples in the prompt to improve the LLM's performance without requiring additional fine-tuning.

After the constrained decoding component performs its operations, the system can use a seventh component to perform embedding generation. The embedding generation component generates embeddings from the merged captions. These embeddings can be used for downstream machine learning applications.

The outputs of an example seven-component system can be configured to be directly interpretable and usable in various applications. These applications can include business logic taxonomy mapping, ranking and recommendation of XR effects, trend analysis of XR content, content moderation, template searching for XR effect creation, and others. Business logic taxonomy mapping involves mapping the generated content tags and descriptions to a standardized taxonomy, allowing for consistent categorization of user preferences, XR usage patterns, and other aspects of an XR-based platform across different systems or applications. Ranking and recommendations of XR effects involves using the textual outputs used to improve the ranking and recommendation of XR effects to users, potentially enhancing user engagement and experience. Trend analysis of XR content allows identification and tracking of emerging trends in XR content creation and usage by analyzing the generated tags and descriptions. Content moderation uses the detailed descriptions and tags generated by the system to assist in identifying potentially inappropriate or problematic XR content for moderation purposes. Template searching for XR effect creation uses the system's outputs to improve search functionality for XR effect templates, making it easier for creators to find and use relevant templates when designing new XR effects. It will be appreciated that numerous other potential applications can make use of structured, standardized textual descriptions and tags associated with XR content, such as providing semantically structured audio descriptions of XR content for visually impaired users.

Examples described herein can span a range of configurations, potentially providing flexible and adaptable approaches to XR content understanding. For example, the content tags generated by the system in some examples can be free-form, allowing for a wide range of descriptions. Alternatively, in other examples the system can be configured to output tags that conform to a specific taxonomy, which can be useful for integrating with other systems or applications that use different categorization schemes.

One potential benefit provided by some examples is the ability to combine information from multiple sources. By incorporating data from the MLLM captions, OCR text, and metadata, the system can generate a more comprehensive understanding of the XR effect than any single source could provide. Some examples also address the challenge of understanding XR effects across different base content. XR effects can vary significantly depending on the base content they are applied to. By focusing on the effect itself rather than the base content, the system can provide consistent and relevant descriptions regardless of the underlying video or image.

In some examples, the system can be extended to handle video input directly, rather than just static frames. This could allow for better understanding of animated XR effects that cannot be fully captured in a single frame.

By addressing the technical problem of generating structured, parsable descriptions of XR effects, described examples can enable a wide range of applications and use cases, from improving content discovery and recommendations to enabling more effective content moderation.

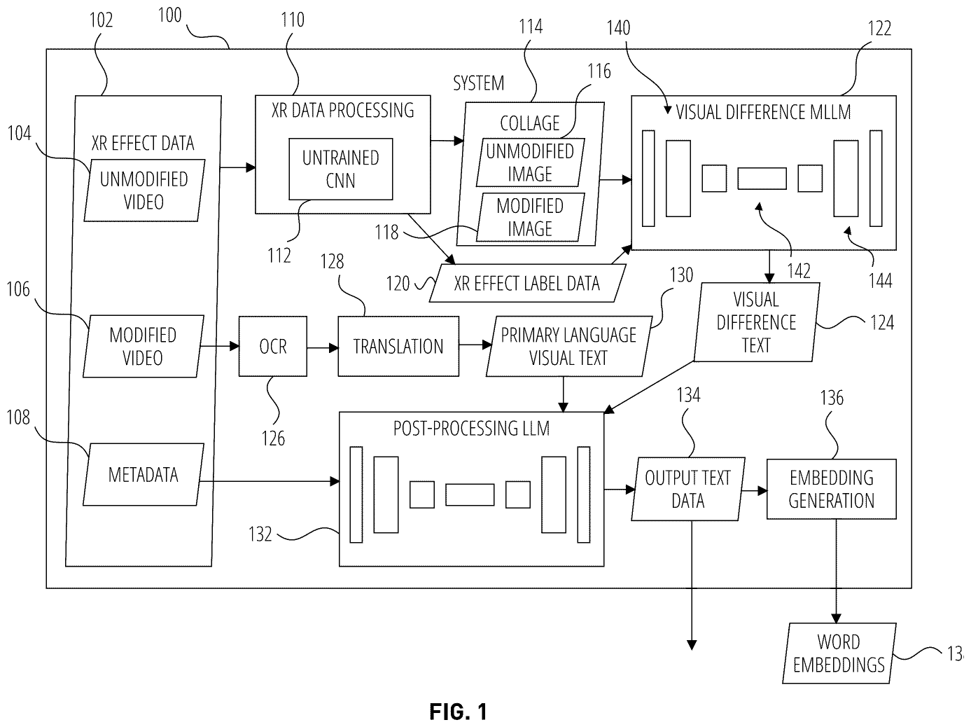

FIG. 1 is a block diagram illustrating a system 100 for processing extended reality (XR) content to generate semantic or textual data characterizing the XR content.

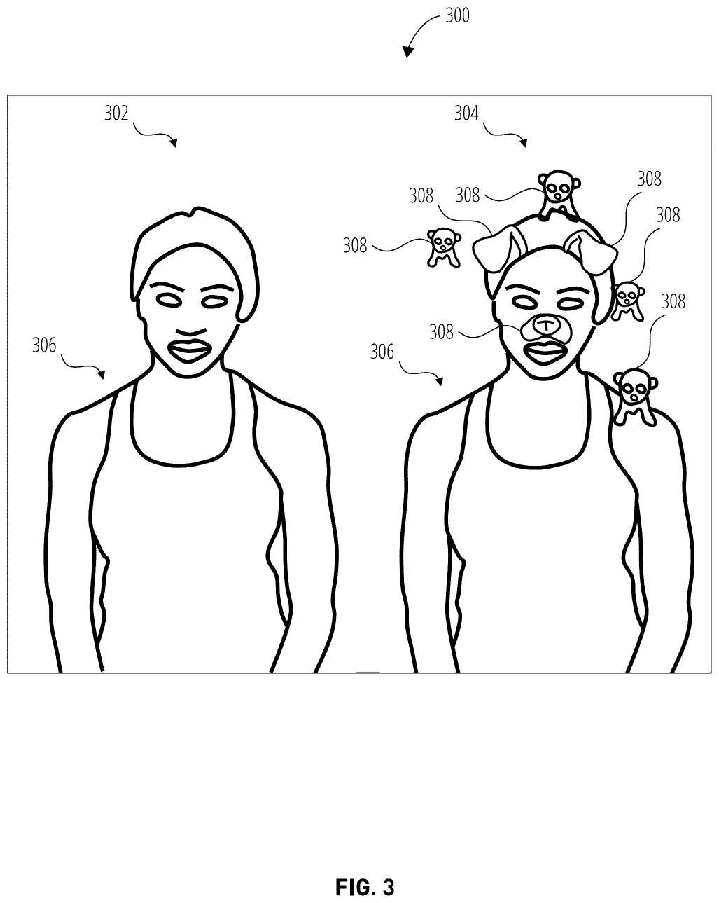

The system 100 receives as input XR effect data 102 for an XR effect, such as an XR filter created by a human artist. An XR effect can include filters, 3D meshes, mesh rigging information, mesh animation information, bitmap information for rendering 3D meshes or 2D effects, and/or other types of information for applying static, dynamic, and/or interactive virtual XR effects or content to real-world content. The XR effect data 102 can includes an unmodified video 104, a corresponding modified video 106, and metadata 108 corresponding to the XR effect. The unmodified video 104 represents original video content without any XR effects applied. The modified video 106 is the result of applying the XR effect to the unmodified video 104, such that the unmodified video includes a first sequence of frames and the modified video 106 includes a second sequence of corresponding frames, wherein each frame of the first sequence of frames is an unmodified frame, and each frame of the second corresponding sequence of frames is a modified frame corresponding to the unmodified frame, but modified by application of the XR effect. The metadata 108 may contain additional information about the XR effect or the video content, such as textual metadata and/or other information describing or characterizing the XR effect. FIG. 3 through FIG. 5, described below, provide examples of different XR effects applied to real-world video content.

Functional blocks of the system 100 shown in FIG. 1 may be referred to herein by their function (e.g., “XR data processing 110”), or as a “component”, “module”, “operation”, “process”, or “block”. Example implementations of each such functional block are described herein, but it will be appreciated by the skilled person that other implementations for these various functional blocks can be substituted in some examples.

The system 100 includes an XR data processing 110 component. XR data processing 110 processes the XR effect data 102 to prepare it for further analysis. In some examples, the XR data processing 110 component extracts or otherwise derives corresponding frames from the unmodified video 104 and the modified video 106 to create a collage 114. The collage 114 produced by the XR data processing 110 component contains an unmodified image 116 and a modified image 118. The unmodified image 116 represents a frame from the unmodified video 104, while the modified image 118 represents the corresponding frame from the modified video 106 with the XR effect applied.

In some examples, an untrained convolutional neural network (CNN) 112 is utilized by the XR data processing 110 component. The untrained CNN 112 may be used to detect differences between frames of the unmodified video 104 and the modified video 106. This process helps identify the most relevant pair of frames that showcase the XR effect.

The untrained CNN 112 is applied to the first sequence of frames (of the unmodified video 104) and the second sequence of corresponding frames (of the modified video 106) to generate embeddings (e.g., 2D visual feature embeddings) of each frame of the first sequence of frames and the second sequence of corresponding frames. A measurement of difference is then computed between the embeddings of each frame of the first sequence of frames and each corresponding frame of the second sequence of corresponding frames. In some examples, the measurement of difference can be computed as a cosine similarity (cos-sim) between the embedding vectors of the two corresponding frames. The lower the similarity, the greater the measurement of difference. Once the measurement of difference has been computed for each pair of corresponding frames of the unmodified video 104 and modified video 106, the pair with the greatest measurement of difference can be selected to form the collage 114: the collage 114 includes the selected unmodified frame as the unmodified image 116, and the corresponding selected modified frame as the modified image 118.

In some examples, XR data processing 110 also processes the metadata 108 of the XR effect data 102 to generate XR effect label data 120. The XR effect label data 120 is textual and may include textual descriptions or text annotations related to the XR effect, which can be extracted directly from the metadata (e.g., from a “title” or “filename” metadata field) or derived from the metadata 108 using rule-based logic such as categorization based on keywords or data field values in the metadata 108.

A trained multimodal generative language model, shown as visual difference MLLM 122, is then used to process the collage 114 and the XR effect label data 120, generating visual difference text 124 as its output. The visual difference MLLM 122 is a multimodal large language model (MLLM) configured to take both image and text data as inputs and to generate text outputs. In some examples, the visual difference MLLM 122 generates visual difference text 124 that describes or characterizes the differences between the unmodified image 116 and the modified image 118, focusing on the differences created by XR effect and de-emphasizing or ignoring common features of the unmodified image 116 and the modified image 118.

In some examples, the visual difference MLLM 122 is configured and trained using a Low-Rank Adaptation (LoRA) technique, based on a multimodal LLM architecture such as BLIP2.

BLIP2 is a multimodal large language model architecture that combines a large image encoder (such as CLIP or a similarly suitable image encoder) and a large language model (e.g., OPT/Flan) through a Querying Transformer (Q-Former) model, enabling BLIP2 to understand both text and images. BLIP2 works by representing images with special tokens alongside associated prompts, and injecting the correct image embeddings during ID lookups, allowing the language model to process both text and image inputs as a set of embeddings for inference purposes. The LLM at the output end of the BLIP2 architecture generates text is its inference outputs. In the illustrated example, the visual difference MLLM 122 is shown as an image encoder 140 to receive and process the collage 114, a Q-Former 142 to receive and process the embeddings from the image encoder 140 along with the XR effect label data 120, and an LLM 144 to receive and process the output of the Q-Former 142 to generate the visual difference text 124. It will be appreciated that the visual difference MLLM 122, or a similarly suitable multimodal generative language model, can be implemented in some examples to process the collage 114 to generate textual outputs characterizing the differences between the unmodified image 116 and modified image 118. In some examples, the multimodal generative language model also processes the XR effect label data 120 as a further input or set of inputs in generating the textual output.

In some examples, the model is trained using the LoRA technique, which can allow for efficient fine-tuning of large models. LoRA works by finding linear layers in attention blocks and performing weight updates on two low-rank weight matrices. This approach enables the model to be trained to focus specifically on describing XR effects applied to the modified image 118 rather than underlying unmodified visual content of the unmodified image 116, while only updating a small percentage (such as around 3-4%) of the model's parameters. Training can be performed using human-generated descriptive labels for a training dataset of collages 114, with or without automated cleaning or other preprocessing of the human-generated labels. The human-generated labels describe the differences applied by the XR effects.

In some examples, a pretrained LLM can be used for the LLM 144, and/or a pretrained image encoder model can be used for the image encoder 140, and LoRA can be used primarily or exclusively to train the Q-Former 142. In other examples, LoRA can also be used to fine-tune the other components of the visual difference MLLM 122, such as the image encoder 140 and/or the LLM 144. By using LoRA for fine-tuning, the system 100 can potentially achieve efficient adaptation of a large MLLM model (such as BLIP2) to the specific task of XR effect description, balancing performance with computational efficiency.

After training, when performing inference on a collage 114, with or without XR effect label data 120 as an additional input, the trained visual difference MLLM 122 generates visual difference text 124 that describes the XR effect in detail. This visual difference text 124 can serve as input for subsequent processing steps, including post-processing by another language model to generate more structured output data, as described below. In some examples, the visual difference MLLM 122 can exploit batch-wise inference to increase the speed and efficiency of computing the measurement of difference across all frames of the videos.

The visual difference text 124 can be combined with additional text data for use by subsequent operations of the system 100. This additional text data can include visual text derived from text visually displayed as part of the XR effect, and/or textual metadata extracted or derived from the metadata 108. The visual text can be derived from the modified video 106 by an optical character recognition (OCR) 126 component, which processes the modified video 106 to identify text rendered by the XR effect. The OCR 126 component outputs visual text, which is textual data representative of text visible within one or more frames of the modified video 106.

In some examples, the OCR 126 component can operate on the modified image 118 instead of frames taken directly from the unmodified video 104. However, in some examples, the unmodified image 116 and modified image 118 included in the collage 114 may be down-sampled to a lower resolution in order to simplify processing by the visual difference MLLM 122, and the OCR 126 component may require a higher-resolution version of the modified image 118, which must be taken from the original-resolution source, namely the modified video 106.

In some examples, the OCR 126 component may be configured to detect text in multiple written languages and/or in multiple different scripts, alphabets, and/or character sets. A translation 128 component can be used to process the visual text output of the OCR 126 component. The translation 128 component may be configured to operate with respect to a primary language, such as English. Text corresponding to words in the primary language may be unaffected by the translation 128 component. However, text corresponding to words in a non-primary language can be translated into the primary language. In some examples, the primary language is a language used in training the post-processing LLM 132 of the system 100, described in greater detail below. In some examples, the translation 128 component may utilize external machine translation services, such as via an application programming interface (API) for accessing a translation service.

The output of the translation 128 component is primary language visual text 130, which can include text originally displayed in the primary language by the XR effect, as well as text originally displayed in a non-primary language by the XR effect: the non-primary language text is translated into the primary language, and may also include additional text annotations indicating the original language, as detected by the translation 128 component. In some examples, a primary language-compatible textual representation of the original non-primary language words may also be included in the primary language visual text 130.

After the primary language visual text 130 and the visual difference text 124 have been generated, they can be combined with each other as inputs to a further generative language model, shown in FIG. 1 as post-processing LLM 132. In some examples, the inputs to the generative language model can also include some or all of the textual content extracted or derived from the metadata 108.

In some examples, the post-processing LLM 132 can be a large language model (LLM) trained or fine-tuned to generate text output (shown as output text data 134) that adheres to a specific standardized format or taxonomy. The output text data 134 can include multiple different formats or types of textual data: for example, the output text data 134 can include three different types of data: one or more content tags generated based on the visual difference text 124, the metadata 108, and the primary language visual text 130; location text describing where within a video frame the XR effect is applied; and a merged caption combining information from other two types of output text.

In some examples, the post-processing LLM 132 uses constrained decoding to ensure that the output text data 134 adheres to a specific structure, such as a JavaScript Object Notation (JSON) format, or a specific taxonomy of predefined tags or caption clause types. The post-processing LLM 132 can be trained and/or operated to perform constrained encoding by using a finite state machine approach for token-level decoding to ensure the output adheres to a specific structure. This approach allows the post-processing LLM 132 to combine information from multiple sources, including the visual difference text 124 generated by the multimodal generative language model (e.g., visual difference MLLM 122), the XR effect title and/or other metadata 108, and OCR-generated visual text (e.g., primary language visual text 130), into a standardized structure, taxonomy, or format such as JSON. During each step of the generation process, the scores for each token are masked so that only valid next tokens can be chosen, ensuring the output conforms to the predefined schema. The post-processing LLM 132 can thereby be configured to generate structured, parsable text outputs that are directly usable in production systems, addressing the challenge of converting freeform MLLM-generated captions into fixed, standardized formats. The constrained decoding process can be adapted to output tags conforming to specific taxonomies, making it useful for integrating with various systems or applications that use different categorization schemes. In some examples, the post-processing LLM 132 does not need to be re-trained in accordance with a new taxonomy or format: instead, the same LLM can be operated to generate inferences with a different masking scheme applied based on the new taxonomy or format. In some examples, to improve the LLM's performance without additional fine-tuning, the system 100 can use in-context examples in the prompt provided to the post-processing LLM 132 to prompt the post-processing LLM 132 to adhere to the desired taxonomy or format. This technique helps guide the post-processing LLM 132 to produce more accurate and relevant outputs within the constraints of the predefined structure.

In some examples, the output text data 134 can be provided as output of the system 100 to other components or software applications. In some examples, an embedding generation 136 component processes the output text data 134 to create word embeddings 138 for use as a further output of the system 100. The embedding generation 136 can include or use a word encoder to generate the word embeddings 138. The word embeddings 138 and/or output text data 134 can be used for downstream software applications, such as ranking and recommendation of XR effects, trend analysis, content moderation, and template searching for XR effect creation.

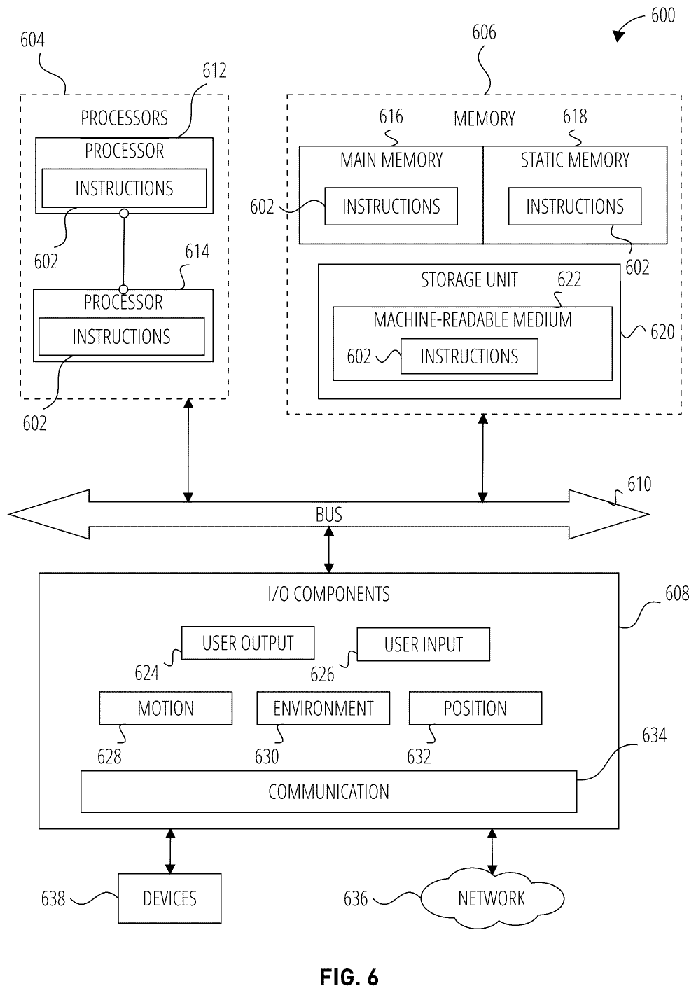

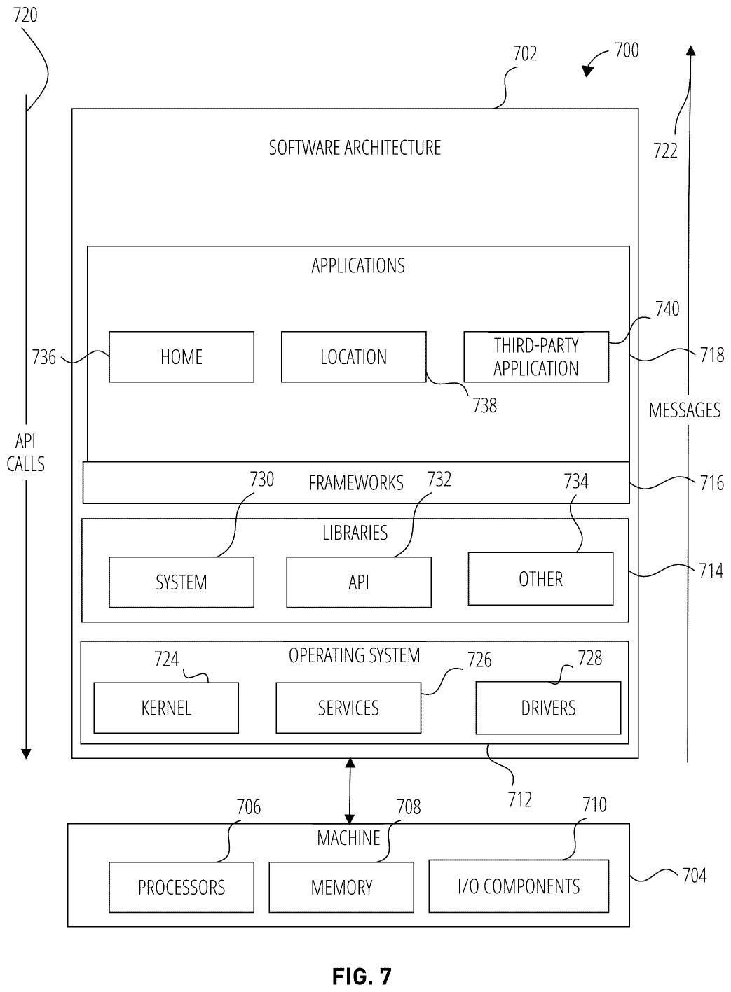

The system 100 may be implemented using various hardware and software components, including processors, memory, and storage devices. The components of the system 100 may communicate with each other through various interfaces and data exchange mechanisms. Examples of hardware and software components suitable for implementing the system 100 are described below with reference to FIG. 6 and FIG. 7.

In some examples, the system 100 can operate on batches of XR effect data 102 encompassing multiple XR effects and their associated video data and metadata. In some examples, the system 100 operates as one or more pipelined processes, such as an OCR/translation pipeline in parallel with a collage/visual difference text pipeline, which are merged to form an output text data/word embeddings pipeline. In some examples, the system 100 can be configured to efficiently process large batches of XR effect data 102 during inference by using web dataset .tar files to stream XR effect data 102 (including large amounts of video data) efficiently from cloud storage buckets.

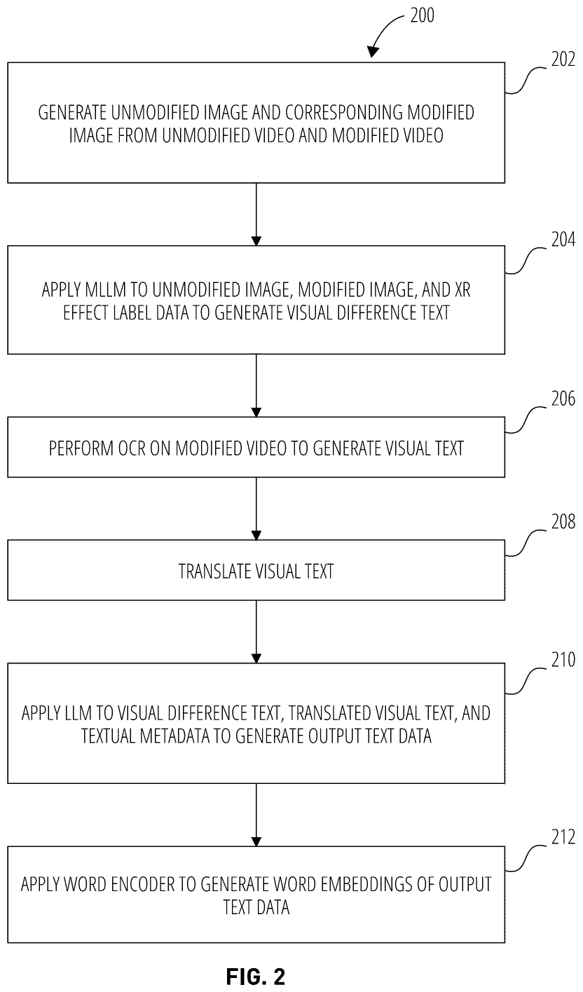

FIG. 2 illustrates an example method 200 for generating standardized text data characterizing an XR effect. Whereas example operations of the method 200 are described with reference to the system 100 of FIG. 1, it will be appreciated that some examples of the method 200 can be performed using other suitable means.

Although the example method 200 depicts a particular sequence of operations, the sequence may be altered without departing from the scope of the present disclosure. For example, some of the operations depicted may be performed in parallel or in a different sequence that does not materially affect the function of the method 200. In other examples, different components of an example device or system that implements the method 200 may perform functions at substantially the same time or in a specific sequence.

The method 200 begins with operation 202. The system 100 obtains an unmodified image 116 and a corresponding modified image 118 from an unmodified video 104 and a modified video 106. This operation may utilize the XR data processing 110 component, and specifically the untrained CNN 112, to extract and select the most relevant frames that highlight the differences created by the XR effect, as described above.

In operation 204, a multimodal large language model (MLLM) or other multimodal generative language model is applied to the unmodified image 116, modified image 118, and XR effect label data 120 to generate the visual difference text 124. This operation 204 corresponds to the function of the visual difference MLLM 122 in FIG. 1. The visual difference MLLM 122 processes the unmodified image 116, modified image 118, and XR effect label data 120 to produce a textual description of the visual differences introduced by the XR effect, such as the visual difference text 124. In some examples, as described above, the XR effect label data 120 can be extracted or otherwise derived from the metadata 108 of the XR effect data 102.

In operation 206, visual text recognition, such as optical character recognition (OCR), is performed on one or more frames of the modified video 106 to generate visual text. Operation 206 utilizes the OCR 126 component to extract text rendered by the XR effect in the modified video 106. The OCR 126 component may be configured to detect text in multiple written languages and/or writing systems, such as English, Arabic, Korean, and so on.

Following the OCR process, operation 208 translates any visual text that is not in the primary language on which the post-processing LLM 132 has been trained. Operation 208 corresponds to the translation 128 component in FIG. 1. In some examples, operation 208 may utilize external translation services, such as via an API.

Operation 210 applies a generative language model, such as a large language model (LLM) to the visual difference text 124, the translated visual text (e.g., primary language visual text 130), and textual metadata 108 to generate output text data 134. Operation 210 can be performed by the post-processing LLM 132 in FIG. 1. The post-processing LLM 132 combines information from multiple sources to produce a comprehensive and standardized description of the XR effect. In some examples, the output text data may include a merged caption, content tags, and location information describing where the XR effects are applied.

In some examples, method 200 includes a final operation 212 in which a word encoder is applied to the output text data 134 to generate word embeddings 138 of the output text data 134. Operation 212 corresponds to the operation of the embedding generation 136 component in FIG. 1. The word embeddings 138 can be used for various downstream software applications, including further machine learning applications.

The method 200 may be implemented using various hardware and software components, including processors, memory, and storage devices, such as those described with reference to FIG. 6 and/or FIG. 7 below. The operations of the method 200 may be performed in the sequence shown in FIG. 2, or in a different order that does not materially affect the function of the method. In some examples, different components of the system implementing the method 200 may perform functions at substantially the same time or in a specific sequence.

FIG. 3 is a collage 300 illustrating a first example of an unmodified frame 302 and a modified frame 304 with an XR effect 308 applied. The collage 300 is an example of a collage 114 generated and processed by components of the system 100 of FIG. 1. The unmodified frame 302 and modified frame 304 correspond to the unmodified image 116 and modified image 118, respectively, of collage 114. In some examples, these frames are selected based on their relevance in showcasing the XR effect, such as by using the untrained CNN 112 to detect significant differences between the frames.

The collage 300 shows a subject 306, in this case a human. The subject 306 appears in both the unmodified frame 302 and the modified frame 304. This subject 306 serves as the base content to which the XR effect is applied.

The XR effect 308 visible in the modified frame 304 includes miniature dogs floating around the subject's head, and dog ears and a dog nose superimposed on the subject's face and head. These visual differences between the unmodified frame 302 and the modified frame 304 are what the visual difference MLLM 122 in FIG. 1 analyzes to generate the visual difference text 124 during operation 204 in FIG. 2.

In some examples, the visual difference MLLM 122 also processes XR effect label data 120 derived from the metadata 108 associated with the XR effect. For example, the XR effect data 102 for the illustrated XR effect 308 can include the following textual metadata 108, which can be encoded as JSON data or similarly structured textual data:

{
″effect_id″: ″4055931830″,
″effect_name″: ″Puppy Love″,
″effect_category″: ″face_transform″,
″effect_tags″: [″dog″, ″animal″, ″cute″, ″beagle″],
″effect_creator″: ″XR Maker″,
″creation_date″: ″2024-03-15″,
″last_modified_date″: “2024-03-20”
}

In some examples, the XR data processing 110 component can be configured to extract certain portions of the metadata 108 (such as the value of the “effect_name” field and/or the “effect tags” values) to generate the XR effect label data 120. Thus, for example, the XR data processing 110 could process the metadata 108 shown above to generate XR effect label data 120 of the form: “Puppy Love dog animal cute beagle”, or “Puppy Love”, or “dog, animal, cute, beagle”, or “Title: Puppy Love; Tags: dog, animal, cute, beagle”, or any other suitable textual representation of one or more salient portions of the metadata 108.

The collage 300 serves as input for subsequent operations in the method 200 of FIG. 2. It can be processed by the visual difference MLLM 122 in operation 204 to generate visual difference text 124 describing the XR effect. For example, the LoRA-trained visual difference MLLM 122 could process the collage 300 and XR effect label data 120 of the form “Title: Puppy Love” to generate visual difference text 124 of the form: “adds puppy ears and nose to the person's face, adds floating puppy dogs around the person's face”. The inclusion of the word “puppy” in the XR effect label data 120 may influence the visual difference MLLM 122 to select the word “puppy” to describe the XR effect seen in the modified frame 304, as opposed to another word such as “dog”.

In this example, there is no text visible in the XR effect 308, so the OCR 126 component would likely return no visual text. However, some or all of the metadata 108 shown above may be processed as inputs to the post-processing LLM 132 along with the visual difference text 124. As a result, the output text data 134 generated by the post-processing LLM 132 may be more likely to refer to a “beagle” or a “beagle puppy” instead of a more generic term.

In some examples, as described above, the output text data 134 can include tags, location text, and a merged caption. By applying constrained decoding to require the output text data 134 to include separate JSON objects for each distinct element in the XR effect 308, the presently described example of FIG. 3 could result in the generation of output text data 134 such as:

{
“effects”: [
{
″caption″: ″dog nose and ears added to the person's face″,
″location″: ″face″,
″tags″: [″dog″, ″transform″, “animal”, “nose”, “ears”]
},
{
″caption″: ″floating beagle puppies around the person's
face″,
″location″: ″face″,
″tags″: [″animal″, ″beagle″, “floating”, “puppy”]
}]
}

Alternatively, by applying constrained decoding to require the output text data 134 to include a single JSON objects for the entire XR effect 308, the presently described example of FIG. 3 could result in the generation of output text data 134 such as:

{
″caption″: ″a dog nose and ears are added to the person's
face, along with beagle puppies floating around the person's
face″,
″location″: ″face″,
″tags″: [″animal″, ″dog″, ″transform″, “animal”, “nose”,
“ears”, “floating”, “puppy”, “beagle”]
}

It will be further appreciated that constrained decoding can be used to constrain other aspects of the output text data 134, such as tags selected from a pre-defined list of tags, predefined terminology for indicating locations, and so on.

It will further be appreciated that formats other than JSON, including freeform text, can be used in some examples for the output text data 134. Some examples can generate the output text data 134 as a natural language caption or descriptive clause, sentence, or paragraph; in some cases, these natural language outputs can be structured as to tone, style, terminology, structure, or other aspects by the use of examples in the prompt provided to the post-processing LLM 132 and/or constrained decoding using masking.

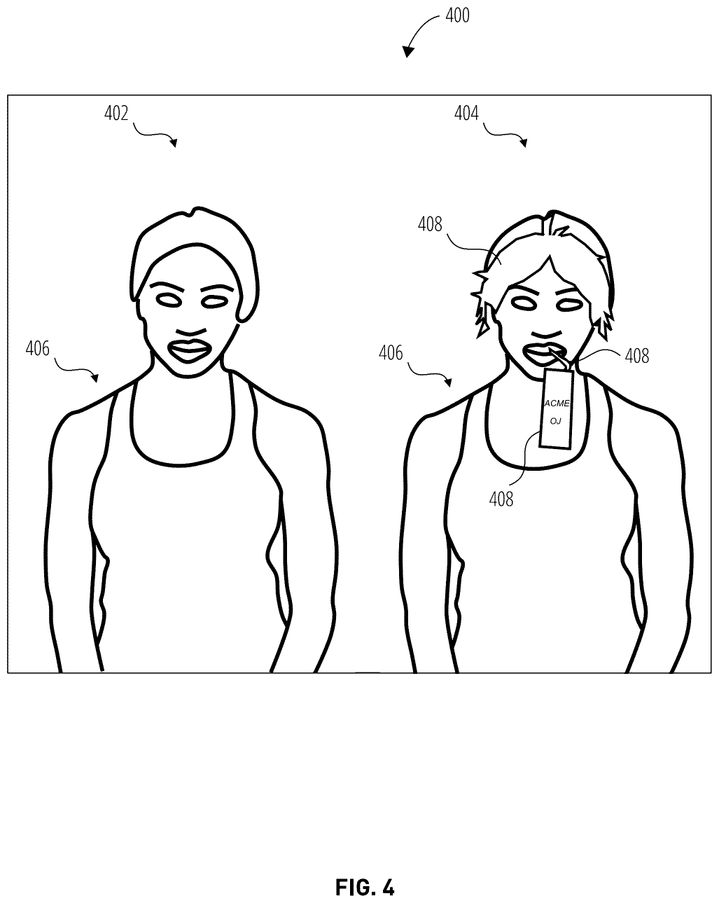

FIG. 4 is a collage 400 illustrating a second example of an unmodified frame 402 and a modified frame 404 with an XR effect 408 applied. Both frames show a human subject 406. The XR effect 408 in this example includes a juice box labeled “ACME OJ” positioned at the subject's neck, with a straw leading to the subject's mouth, and a wig superimposed on the subject's head.

This collage 400 demonstrates a difference from collage 300 of FIG. 3 in that collage 400 includes visible text as part of the XR effect 408. The “ACME OJ” label on the juice box is detected and decoded by the OCR 126 component of the system 100 during operation 206 of the method 200 in FIG. 2. The presence of this English text in the XR effect 408 means that the translation 128 component (performing operation 208 in FIG. 2) may not need to perform any translation in this case, as the text is already in the primary language understood by the post-processing LLM 132 (English, in this example). Thus, the system 100 may generate primary language visual text 130 of the form: “ACME OJ”.

In this example, the visual difference MLLM 122 may process the collage 400 (and optionally XR effect label data 120, such as an effect title, “Yummy Juice”) to generate visual difference text 124 of the form: “adds a juice box with a straw at the person's neck and a wig on the person's head”. Additionally, the textual metadata 108 from the XR effect data 102 may indicate a brand name and product name of the juice box product, such as “Acme Brand Fresh Squeezed Orange Juice”.

As a result, the post-processing LLM 132 may process the metadata 108 (e.g., “Acme Brand Fresh Squeezed Orange Juice”), the primary language visual text 130 (e.g., “ACME OJ”), and the visual difference text 124 (e.g., “adds a juice box with a straw at the person's neck and a wig on the person's head”) to generate output text data 134 including a caption of the form: “adds an Acme Brand Fresh Squeezed Orange Juice box with a straw at the person's neck and a wig on the person's head”.

This combination of OCR-detected text (“ACME OJ”) and metadata (“Acme Brand Pure Orange Juice”) with the visual difference text 124 can result in more detailed and accurate output text data 134. In addition to the merged caption, the post-processing LLM 132 may also generate content tags related to juice, orange juice, and the Acme brand, as well as location information indicating the placement of the juice box at the subject's neck and/or the wig on the subject's head. For example, the output text data 134 could be structured as JSON object such as:

{
″caption″: “adds an Acme Brand Fresh Squeezed Orange Juice
box with a straw at the person's neck and a wig on the
person's head”,
″locations″: [″neck″, ″head″],
″tags″: [″juice″, ″wig″, ″Acme″, “brand”, “orange”, “OJ”,
“box”, “straw”, “fresh”, “squeezed”]
}

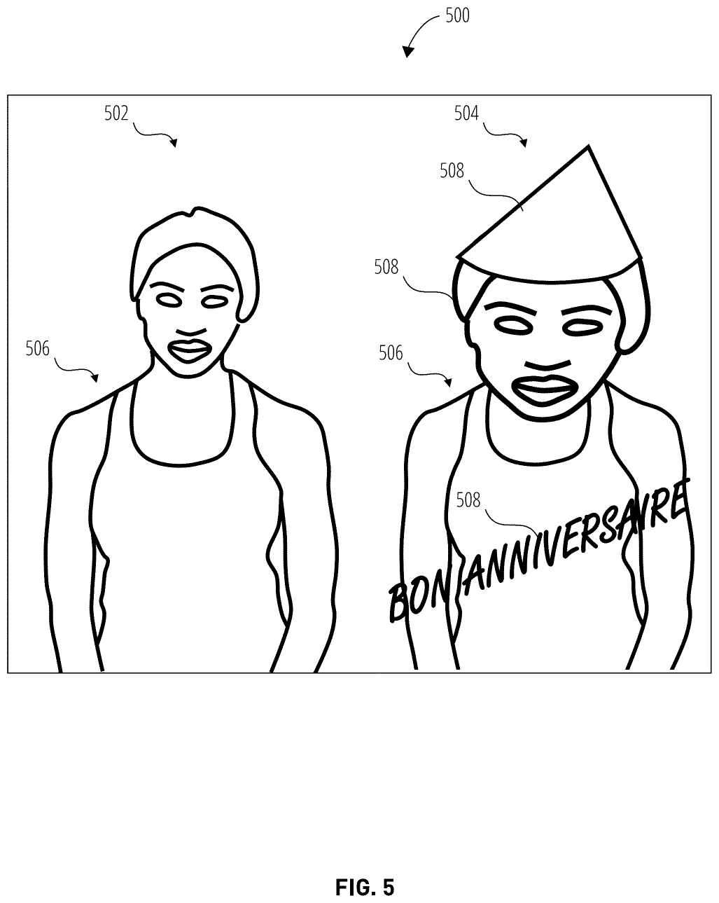

FIG. 5 is a collage 500 illustrating a third example of an unmodified frame 502 and a modified frame 504 with an XR effect 508 applied. Both frames show a subject 506.

This example demonstrates the inclusion of non-English visual text as part of the XR effect 508. The XR effect 508 includes enlargement of the subject's head, a birthday party hat superimposed on the subject's head, and French text reading “Bon Anniversaire” positioned near the bottom of the modified frame 504.

The non-English text (“Bon Anniversaire”) may be detected by the OCR 126 component during operation 206 of the method 200 in FIG. 2. Unlike the English text in FIG. 4, this French text requires translation. The translation 128 component, performing operation 208 in FIG. 2, processes this non-primary language text to translate “Bon Anniversaire” to its English equivalent, “Happy Birthday”. This translated text is then provided as primary language visual text 130 to the post-processing LLM 132. In some examples, the primary language visual text 130 can also include an indication of the original language (e.g., “French”) and/or the original non-primary language text (e.g., “Bon Anniversaire”). The post-processing LLM 132 incorporates the primary language visual text 130, along with the other inputs (e.g., visual difference text 124 and metadata 108) to generate the output text data 134 in operation 210 of FIG. 2.

The presence of the birthday party hat and the translated birthday greeting would likely result in content tags related to birthdays and celebrations, as well as location information indicating the placement of the hat on the subject's head and the text at the bottom of the frame. For example, the output text data 134 could be structured as JSON object such as:

{
″caption″: ″the person's head is magnified, with a party hat
added to the head and a French birthday greeting at the
bottom of the frame (′Bon Anniversaire′, Happy Birthday)″,
″locations″: [″bottom″, ″head″],
″tags″: [″happy″, ″birthday″, ″French″, “text”, ″party″,
“hat”, “distort”, “head”, “magnify”]
}

### Machine Architecture

FIG. 6 is a diagrammatic representation of a machine 600 within which instructions 602 (e.g., software, a program, an application, an applet, an app, or other executable code) for causing the machine 600 to perform any one or more of the methodologies discussed herein may be executed. For example, the instructions 602 may implement all or part of the functionality of the system 100 and cause the machine 600 to execute any one or more of the methods described herein, such as method 200. The instructions 602 transform the general, non-programmed machine 600 into a particular machine 600 programmed to carry out the described and illustrated functions in the manner described. The machine 600 may operate as a standalone device or may be coupled (e.g., networked) to other machines. In a networked deployment, the machine 600 may operate in the capacity of a server machine or a client machine in a server-client network environment, or as a peer machine in a peer-to-peer (or distributed) network environment. The machine 600 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch, a pair of augmented reality glasses), a smart home device (e.g., a smart appliance), other smart devices, a web appliance, a network router, a network switch, a network bridge, or any machine capable of executing the instructions 602, sequentially or otherwise, that specify actions to be taken by the machine 600. Further, while a single machine 600 is illustrated, the term “machine” shall also be taken to include a collection of machines that individually or jointly execute the instructions 602 to perform any one or more of the methodologies discussed herein. In some examples, the machine 600 may comprise both client and server systems, with certain operations of a particular method or algorithm being performed on the server-side and with certain operations of the particular method or algorithm being performed on the client-side.

The machine 600 may include processors 604, memory 606, and input/output I/O components 608, which may be configured to communicate with each other via a bus 610. In an example, the processors 604 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 612 and a processor 614 that execute the instructions 602. The term “processor” is intended to include multi-core processors that may comprise two or more independent processors (sometimes referred to as “cores”) that may execute instructions contemporaneously. Although FIG. 6 shows multiple processors 604, the machine 600 may include a single processor with a single-core, a single processor with multiple cores (e.g., a multi-core processor), multiple processors with a single core, multiple processors with multiples cores, or any combination thereof.

The memory 606 includes a main memory 616, a static memory 618, and a storage unit 620, both accessible to the processors 604 via the bus 610. The main memory 606, the static memory 618, and storage unit 620 store the instructions 602 embodying any one or more of the methodologies or functions described herein. The instructions 602 may also reside, completely or partially, within the main memory 616, within the static memory 618, within machine-readable medium 622 within the storage unit 620, within at least one of the processors 604 (e.g., within the processor's cache memory), or any suitable combination thereof, during execution thereof by the machine 600.

The I/O components 608 may include a wide variety of components to receive input, provide output, produce output, transmit information, exchange information, capture measurements, and so on. The specific I/O components 608 that are included in a particular machine will depend on the type of machine. For example, portable machines such as mobile phones may include a touch input device or other such input mechanisms, while a headless server machine will likely not include such a touch input device. It will be appreciated that the I/O components 608 may include many other components that are not shown in FIG. 6. In various examples, the I/O components 608 may include user output components 624 and user input components 626. The user output components 624 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 626 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 608 may include motion components 628, environmental components 630, or position components 632, among a wide array of other components. The motion components 628 can include acceleration sensor components (e.g., accelerometer), gravitation sensor components, and/or rotation sensor components (e.g., gyroscope).

The environmental components 630 include, for example, one or more cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), depth sensors (such as one or more LIDAR arrays), or other components that may provide indications, measurements, or signals corresponding to a surrounding physical environment.

With respect to cameras, the machine 600 may have a camera system comprising, for example, front cameras on a front surface of the machine 600 and rear cameras on a rear surface of the machine 600. The front cameras may, for example, be used to capture still images and video of a user of the machine 600 (e.g., “selfies”), which may then be augmented with augmentation data (e.g., filters) described above. The rear cameras may, for example, be used to capture still images and videos in a more traditional camera mode, with these images similarly being augmented with augmentation data. In addition to front and rear cameras, the machine 600 may also include a 360° camera for capturing 360° photographs and videos.

Further, the camera system of the machine 600 may include dual rear cameras (e.g., a primary camera as well as a depth-sensing camera), or even triple, quad or penta rear camera configurations on the front and rear sides of the machine 600. These multiple cameras systems may include a wide camera, an ultra-wide camera, a telephoto camera, a macro camera, and a depth sensor, for example.

The position components 632 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 608 further include communication components 634 operable to couple the machine 600 to a network 636 or devices 638 via respective coupling or connections. For example, the communication components 634 may include a network interface component or another suitable device to interface with the network 636. In further examples, the communication components 634 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 638 may be another machine or any of a wide variety of peripheral devices (e.g., a peripheral device coupled via a USB).

Moreover, the communication components 634 may detect identifiers or include components operable to detect identifiers. For example, the communication components 634 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph™, MaxiCode, PDF417, Ultra Code, UCC RSS-2D bar code, and other optical codes), or acoustic detection components (e.g., microphones to identify tagged audio signals). In addition, a variety of information may be derived via the communication components 634, such as location via Internet Protocol (IP) geolocation, location via Wi-Fi® signal triangulation, location via detecting an NFC beacon signal that may indicate a particular location, and so forth.

The various memories (e.g., main memory 616, static memory 618, and memory of the processors 604) and storage unit 620 may store one or more sets of instructions and data structures (e.g., software) embodying or used by any one or more of the methodologies or functions described herein. These instructions (e.g., the instructions 602), when executed by processors 604, cause various operations to implement the disclosed examples.

The instructions 602 may be transmitted or received over the network 636, using a transmission medium, via a network interface device (e.g., a network interface component included in the communication components 634) and using any one of several well-known transfer protocols (e.g., hypertext transfer protocol (HTTP)). Similarly, the instructions 602 may be transmitted or received using a transmission medium via a coupling (e.g., a peer-to-peer coupling) to the devices 638.

### Software Architecture

FIG. 7 is a block diagram 700 illustrating a software architecture 702, which can be installed on any one or more of the devices described herein. The software architecture 702 is supported by hardware such as a machine 704 that includes processors 706, memory 708, and I/O components 710. In this example, the software architecture 702 can be conceptualized as a stack of layers, where each layer provides a particular functionality. The software architecture 702 includes layers such as an operating system 712, libraries 714, frameworks 716, and applications 718. Operationally, the applications 718 invoke API calls 720 through the software stack and receive messages 722 in response to the API calls 720. The system 100 may be implemented by components in one or more layers of the software architecture 702.

The operating system 712 manages hardware resources and provides common services. The operating system 712 includes, for example, a kernel 724, services 726, and drivers 728. The kernel 724 acts as an abstraction layer between the hardware and the other software layers. For example, the kernel 724 provides memory management, processor management (e.g., scheduling), component management, networking, and security settings, among other functionalities. The services 726 can provide other common services for the other software layers. The drivers 728 are responsible for controlling or interfacing with the underlying hardware. For instance, the drivers 728 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 714 provide a common low-level infrastructure used by the applications 718. The libraries 714 can include system libraries 730 (e.g., C standard library) that provide functions such as memory allocation functions, string manipulation functions, mathematic functions, and the like. In addition, the libraries 714 can include API libraries 732 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 714 can also include a wide variety of other libraries 734 to provide many other APIs to the applications 718.

The frameworks 716 provide a common high-level infrastructure that is used by the applications 718. For example, the frameworks 716 provide various graphical user interface (GUI) functions, high-level resource management, and high-level location services. The frameworks 716 can provide a broad spectrum of other APIs that can be used by the applications 718, some of which may be specific to a particular operating system or platform.

In an example, the applications 718 may include a home application 736, a location application 738, and a broad assortment of other applications such as a third-party application 740. The applications 718 are programs that execute functions defined in the programs. Various programming languages can be employed to create one or more of the applications 718, structured in a variety of manners, such as object-oriented programming languages (e.g., Objective-C, Java, or C++) or procedural programming languages (e.g., C or assembly language). In a specific example, the third-party application 740 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 740 can invoke the API calls 720 provided by the operating system 712 to facilitate functionalities described herein.

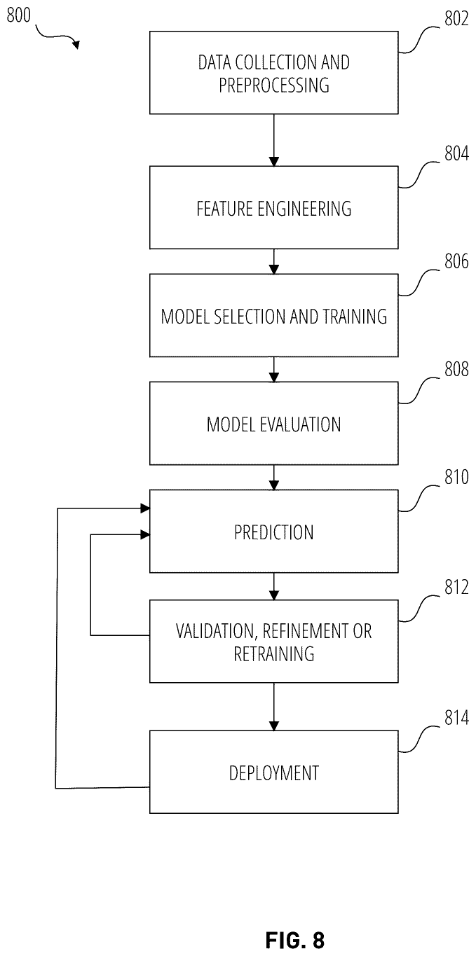

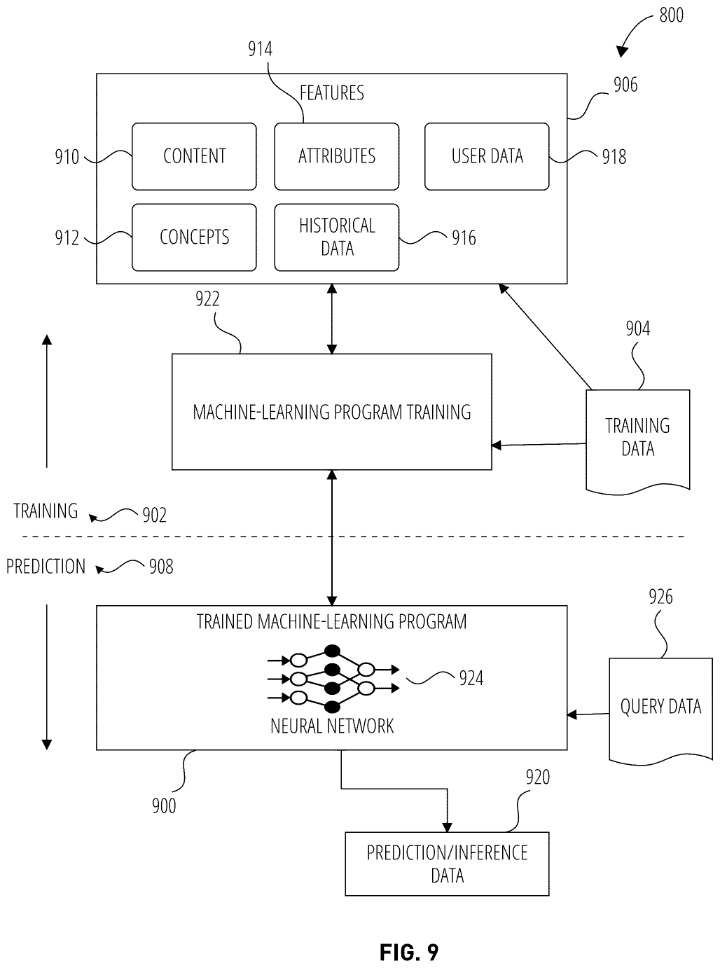

FIG. 8 is a flowchart depicting a machine-learning pipeline 800, according to some examples. The machine-learning pipeline 800 may be used to generate a trained model, for example the trained machine-learning program 900 of FIG. 9, to perform operations associated with searches and query responses.

Broadly, machine learning may involve using computer algorithms to automatically learn patterns and relationships in data, potentially without the need for explicit programming. Machine learning algorithms can be divided into three main categories: supervised learning, unsupervised learning, and reinforcement learning.
Supervised learning involves training a model using labeled data to predict an output for new, unseen inputs. Examples of supervised learning algorithms include linear regression, decision trees, and neural networks.
Unsupervised learning involves training a model on unlabeled data to find hidden patterns and relationships in the data. Examples of unsupervised learning algorithms include clustering, principal component analysis, and generative models like autoencoders.
Reinforcement learning involves training a model to make decisions in a dynamic environment by receiving feedback in the form of rewards or penalties. Examples of reinforcement learning algorithms include Q-learning and policy gradient methods.

Examples of specific machine learning algorithms that may be deployed, according to some examples, include logistic regression, which is a type of supervised learning algorithm used for binary classification tasks. Logistic regression models the probability of a binary response variable based on one or more predictor variables. Another example type of machine learning algorithm is Naïve Bayes, which is another supervised learning algorithm used for classification tasks. Naïve Bayes is based on Bayes' theorem and assumes that the predictor variables are independent of each other. Random Forest is another type of supervised learning algorithm used for classification, regression, and other tasks. Random Forest builds a collection of decision trees and combines their outputs to make predictions. Further examples include neural networks, which consist of interconnected layers of nodes (or neurons) that process information and make predictions based on the input data. Matrix factorization is another type of machine learning algorithm used for recommender systems and other tasks. Matrix factorization decomposes a matrix into two or more matrices to uncover hidden patterns or relationships in the data. Support Vector Machines (SVM) are a type of supervised learning algorithm used for classification, regression, and other tasks. SVM finds a hyperplane that separates the different classes in the data. Other types of machine learning algorithms include decision trees, k-nearest neighbors, clustering algorithms, and deep learning algorithms such as convolutional neural networks (CNN), recurrent neural networks (RNN), and transformer models. The choice of algorithm depends on the nature of the data, the complexity of the problem, and the performance requirements of the application.

The performance of machine learning models is typically evaluated on a separate test set of data that was not used during training to ensure that the model can generalize to new, unseen data.

Although several specific examples of machine learning algorithms are discussed herein, the principles discussed herein can be applied to other machine learning algorithms as well. Deep learning algorithms such as convolutional neural networks, recurrent neural networks, and transformers, as well as more traditional machine learning algorithms like decision trees, random forests, and gradient boosting may be used in various machine learning applications.

Two example types of problems in machine learning are classification problems and regression problems. Classification problems, also referred to as categorization problems, aim at classifying items into one of several category values (for example, is this object an apple or an orange?). Regression algorithms aim at quantifying some items (for example, by providing a value that is a real number).

Generating a trained machine-learning program 900 may include multiple phases that form part of the machine-learning pipeline 800, including for example the following phases illustrated in FIG. 8:
Data collection and preprocessing 802: This phase may include acquiring and cleaning data to ensure that it is suitable for use in the machine learning model. This phase may also include removing duplicates, handling missing values, and converting data into a suitable format.
Feature engineering 804: This phase may include selecting and transforming the training data 904 to create features that are useful for predicting the target variable. Feature engineering may include (1) receiving features 906 (e.g., as structured or labeled data in supervised learning) and/or (2) identifying features 906 (e.g., unstructured or unlabeled data for unsupervised learning) in training data 904 (all shown in FIG. 9).
Model selection and training 806: This phase may include selecting an appropriate machine learning algorithm and training it on the preprocessed data. This phase may further involve splitting the data into training and testing sets, using cross-validation to evaluate the model, and tuning hyperparameters to improve performance.
Model evaluation 808: This phase may include evaluating the performance of a trained model (e.g., the trained machine-learning program 900) on a separate testing dataset. This phase can help determine if the model is overfitting or underfitting and determine whether the model is suitable for deployment.
Prediction 810: This phase involves using a trained model (e.g., trained machine-learning program 900) to generate predictions on new, unseen data.
Validation, refinement or retraining 812: This phase may include updating a model based on feedback generated from the prediction phase, such as new data or user feedback.
Deployment 814: This phase may include integrating the trained model (e.g., the trained machine-learning program 900) into a more extensive system or application, such as a web service, mobile app, or IoT device. This phase can involve setting up APIs, building a user interface, and ensuring that the model is scalable and can handle large volumes of data.

FIG. 9 illustrates further details of two example phases, namely a training phase 902 (e.g., part of the model selection and trainings 806) and a prediction phase 908 (part of prediction 810). Prior to the training phase 902, feature engineering 804 is used to identify features 906. This may include identifying informative, discriminating, and independent features for effectively operating the trained machine-learning program 900 in pattern recognition, classification, and regression. In some examples, the training data 904 includes labeled data, known for pre-identified features 906 and one or more outcomes. Each of the features 906 may be a variable or attribute, such as an individual measurable property of a process, article, system, or phenomenon represented by a data set (e.g., the training data 904). Features 906 may also be of different types, such as numeric features, strings, and graphs, and may include one or more of content 910, concepts 912, attributes 914, historical data 916, and/or user data 918, merely for example.

In training phase 902, the machine-learning pipeline 800 uses the training data 904 to find correlations among the features 906 that affect a predicted outcome or prediction/inference data 920.

With the training data 904 and the identified features 906, the trained machine-learning program 900 is trained during the training phase 902 during machine-learning program training 922. The machine-learning program training 922 appraises values of the features 906 as they correlate to the training data 904. The result of the training is the trained machine-learning program 900 (e.g., a trained or learned model).

Further, the training phase 902 may involve machine learning, in which the training data 904 is structured (e.g., labeled during preprocessing operations). The trained machine-learning program 900 implements a neural network 924 capable of performing, for example, classification and clustering operations. In other examples, the training phase 902 may involve deep learning, in which the training data 904 is unstructured, and the trained machine-learning program 900 implements a deep neural network 924 that can perform both feature extraction and classification/clustering operations.

In some examples, a neural network 226 may be generated during the training phase 902, and implemented within the trained machine-learning program 900. The neural network 924 includes a hierarchical (e.g., layered) organization of neurons, with each layer consisting of multiple neurons or nodes. Neurons in the input layer receive the input data, while neurons in the output layer produce the final output of the network. Between the input and output layers, there may be one or more hidden layers, each consisting of multiple neurons.

Each neuron in the neural network 924 operationally computes a function, such as an activation function, which takes as input the weighted sum of the outputs of the neurons in the previous layer, as well as a bias term. The output of this function is then passed as input to the neurons in the next layer. If the output of the activation function exceeds a certain threshold, an output is communicated from that neuron (e.g., transmitting neuron) to a connected neuron (e.g., receiving neuron) in successive layers. The connections between neurons have associated weights, which define the influence of the input from a transmitting neuron to a receiving neuron. During the training phase, these weights are adjusted by the learning algorithm to optimize the performance of the network. Different types of neural networks may use different activation functions and learning algorithms, affecting their performance on different tasks. The layered organization of neurons and the use of activation functions and weights enable neural networks to model complex relationships between inputs and outputs, and to generalize to new inputs that were not seen during training.

In some examples, the neural network 924 may also be one of several different types of neural networks, such as a single-layer feed-forward network, a Multilayer Perceptron (MLP), an Artificial Neural Network (ANN), a Recurrent Neural Network (RNN), a Long Short-Term Memory Network (LSTM), a Bidirectional Neural Network, a symmetrically connected neural network, a Deep Belief Network (DBN), a Convolutional Neural Network (CNN), a Generative Adversarial Network (GAN), an Autoencoder Neural Network (AE), a Restricted Boltzmann Machine (RBM), a Hopfield Network, a Self-Organizing Map (SOM), a Radial Basis Function Network (RBFN), a Spiking Neural Network (SNN), a Liquid State Machine (LSM), an Echo State Network (ESN), a Neural Turing Machine (NTM), or a Transformer Network, merely for example.

In addition to the training phase 902, a validation phase may be performed on a separate dataset known as the validation dataset. The validation dataset is used to tune the hyperparameters of a model, such as the learning rate and the regularization parameter. The hyperparameters are adjusted to improve the model's performance on the validation dataset.

Once a model is fully trained and validated, in a testing phase, the model may be tested on a new dataset. The testing dataset is used to evaluate the model's performance and ensure that the model has not overfitted the training data.

In prediction phase 908, the trained machine-learning program 900 uses the features 906 for analyzing query data 926 to generate inferences, outcomes, or predictions, as examples of a prediction/inference data 920. For example, during prediction phase 908, the trained machine-learning program 900 generates an output. Query data 926 is provided as an input to the trained machine-learning program 900, and the trained machine-learning program 900 generates the prediction/inference data 920 as output, responsive to receipt of the query data 926.

In some examples, the trained machine-learning program 900 may be a generative AI model. Generative AI is a term that may refer to any type of artificial intelligence that can create new content from training data 904. For example, generative AI can produce text, images, video, audio, code, or synthetic data similar to the original data but not identical.

Some of the techniques that may be used in generative AI are:
Convolutional Neural Networks (CNNs): CNNs may be used for image recognition and computer vision tasks. CNNs may, for example, be designed to extract features from images by using filters or kernels that scan the input image and highlight important patterns.
Recurrent Neural Networks (RNNs): RNNs may be used for processing sequential data, such as speech, text, and time series data, for example. RNNs employ feedback loops that allow them to capture temporal dependencies and remember past inputs.
Generative adversarial networks (GANs): GNNs may include two neural networks: a generator and a discriminator. The generator network attempts to create realistic content that can “fool” the discriminator network, while the discriminator network attempts to distinguish between real and fake content. The generator and discriminator networks compete with each other and improve over time.
Variational autoencoders (VAEs): VAEs may encode input data into a latent space (e.g., a compressed representation) and then decode it back into output data. The latent space can be manipulated to generate new variations of the output data. VAEs may use self-attention mechanisms to process input data, allowing them to handle long text sequences and capture complex dependencies.
Transformer models: Transformer models may use attention mechanisms to learn the relationships between different parts of input data (such as words or pixels) and generate output data based on these relationships. Transformer models can handle sequential data, such as text or speech, as well as non-sequential data, such as images or code.

In generative AI examples, the output prediction/inference data 222 include predictions, translations, summaries or media content.

### CONCLUSION

The described extended reality (XR) effect understanding systems and methods can provide text and/or word embeddings that can be used by a versatile range of useful applications across various domains. Content moderation is an example use case, enabling automated detection of potentially inappropriate XR content for human review, thus enhancing platform safety and user experience. The system's ability to generate detailed descriptions of XR effects can be leveraged to create audio descriptions, improving accessibility for visually impaired users. In the realm of user experience, the system could power robust search and discovery features, allowing users to find relevant XR effects using natural language queries, thereby improving content discoverability. The system's analytical capabilities enable trend analysis in XR content creation and usage, providing valuable insights for content creators, marketers, and platform managers. Personalized XR effect recommendations can be generated based on user preferences and behavior, potentially increasing user engagement and satisfaction. The system may also facilitate cross-platform XR effect mapping, enabling interoperability and data sharing between different XR platforms or ecosystems. For content creators, the system can improve the search functionality for XR effect templates, streamlining the creation process by helping creators find relevant starting points more efficiently. In addition, the system could enable automated categorization of XR effects into predefined categories, facilitating efficient organization and management of large libraries of XR content. These diverse applications demonstrate the potential of the described examples to significantly enhance various aspects of XR content creation, management, and user interaction.

Examples described herein may address one or more technical problems associated with processing XR content.

A first technical problem arises from non-standardized outputs from Multimodal Large Language Models (MLLMs). MLLMs can generate captions for XR effects, but these outputs are typically freeform and non-standardized, making them unsuitable for direct use in production systems that require fixed, parsable outputs. Some examples described herein implement a post-processing system that uses constrained decoding to generate structured, parsable outputs. This system employs a Large Language Model (LLM) with a finite state machine approach for token-level decoding, ensuring that the output adheres to a specific structure, such as a JSON format. This approach allows for the generation of standardized outputs that can be directly used in production systems for various applications, including business logic taxonomy mapping, ranking and recommendation of XR effects, trend analysis, content moderation, and template searching for XR effect creation.

A second technical problem is the inability of generative AI models to utilize post-training information. Additional information about XR content is often made available after the MLLM has been trained, which the MLLM cannot directly utilize. Some examples described herein address this issue by implementing a post-processing system that combines multiple sources of information. The system includes components for OCR text extraction, translation, and post-processing using an LLM. The OCR pipeline can detect text in multiple written languages, such as English and Arabic, from high-resolution rendered frames. A translation component is then used to translate non-primary language content into the primary language used by the system's language model. The post-processing LLM then combines information from the BLIP2 captions, XR effect title, OCR text, and any additional metadata to generate a comprehensive description of the XR effect. This approach allows the system to incorporate new information that was not available during the initial MLLM training, resulting in more accurate and detailed descriptions of XR effects.

A third technical problem is the difficulty in analyzing and categorizing XR effects across different base content. XR effects can vary significantly depending on the base content they are applied to, making it challenging to provide consistent and relevant descriptions. Some examples described herein address this problem by focusing on the effect itself rather than the base content. The system uses a MLLM, such as a BLIP2 model, which is fine-tuned using LoRA (Low-Rank Adaptation) and trained to focus on describing the XR effects rather than the underlying content. This approach allows the system to provide consistent and relevant descriptions of XR effects regardless of the underlying video or image, enabling better understanding and categorization of XR effects across different base content.

A fourth technical problem is the inefficiency of processing of large-scale XR content. Processing and analyzing millions of XR effects can be computationally expensive and time-consuming, especially when dealing with high-resolution images and videos. Some examples described herein implement one or more efficiency-enhancing techniques. For model training, LoRA can be used for efficient fine-tuning of large models by updating only a small percentage (around 3-4%) of the model's parameters. For inference, the system can uses web dataset .tar files to stream data efficiently from cloud storage buckets. The rendering detection process can use an untrained convolutional neural network to capture basic 2D statistics of images, allowing for fast batch-wise inference across all frames. These optimizations can enable the system to process large volumes of XR content efficiently, making it suitable for production-scale applications.

A fifth technical problem arises from the difficulty in understanding multilingual XR content. XR effects may include text in various languages, which can be challenging for a system primarily trained on a single language. Some examples described herein incorporate an OCR/translation pipeline that can detect text in multiple written languages, such as English and Arabic, and translate non-primary language content into the primary language used by the system's language model. This approach allows the system to understand and process XR effects that contain text in various languages, providing a more comprehensive analysis of multilingual XR content.

By addressing one or more of these technical problems, the described examples may enable more accurate, efficient, and versatile processing of XR effects, supporting a wide range of applications in XR content creation, discovery, and management.

### EXAMPLES

In view of the disclosure above, various examples are set forth below. It should be noted that one or more features of an example, taken in isolation or combination, should be considered within the disclosure of this application.

Example 1 is a system comprising: at least one processor; and a memory storing instructions that, when executed by the at least one processor, configure the system to perform operations comprising: obtaining an unmodified image and a modified image, the modified image comprising the unmodified image modified by an extended reality (XR) effect; applying a trained multimodal generative language model to the unmodified image and the modified image to generate visual difference text descriptive of visual differences between the modified image and the unmodified image; obtaining additional text data associated with the XR effect; and applying a trained generative language model to the visual difference text and the additional text data to generate output text data descriptive of the XR effect.

In Example 2, the subject matter of Example 1 includes, wherein: the obtaining of the unmodified image and a modified image comprises: processing a first sequence of frames of an unmodified video and a second sequence of corresponding frames of a modified video to generate a collage comprising the unmodified image and the modified image, the modified video comprising the unmodified video modified by the XR effect, the unmodified image and the modified image corresponding to an unmodified frame from the unmodified video and a corresponding modified frame from the modified video selected based on a measurement of difference between the unmodified frame and the corresponding modified frame.

In Example 3, the subject matter of Example 2 includes, wherein: the processing the sequence of frames of the unmodified video and the corresponding sequence of frames of the modified video comprises: applying an untrained convolutional neural network to the first sequence of frames and the second sequence of corresponding frames to generate embeddings of the first sequence of frames and the second sequence of corresponding frames; computing the measurement of difference between the embeddings of each frame of the first sequence of frames and each corresponding frame of the second sequence of corresponding frames; and selecting the unmodified frame and the modified frame based on the computed measurement of difference.

In Example 4, the subject matter of Examples 1-3 includes, wherein: the operations further comprise: processing textual metadata associated with the XR effect to generate XR effect label data; and the applying of the trained multimodal generative language model to the unmodified image and the modified image comprises: providing the XR effect label data as a further input to the trained multimodal generative language model to generate the visual difference text.

In Example 5, the subject matter of Examples 1-4 includes, wherein: the additional text data comprises textual metadata associated with the XR effect.

In Example 6, the subject matter of Examples 1-5 includes, wherein: the additional text data comprises visual text displayed as part of the XR effect.

In Example 7, the subject matter of Example 6 includes, wherein: the obtaining of the additional text data comprises: performing optical character recognition on a frame of a modified video to generate the visual text, the modified video comprising a video modified by the XR effect.

In Example 8, the subject matter of Example 7 includes, wherein: the visual text is not in a primary language for which the generative language model has been trained; and the generating of the visual text further comprises performing machine translation of the visual text to generate primary language visual text in the primary language.

In Example 9, the subject matter of Examples 1-8 includes, wherein: the operations further comprise: applying a word encoder to the output text data to generate word embeddings of the output text data.

In Example 10, the subject matter of Examples 1-9 includes, wherein: the output text data comprises a caption.

In Example 11, the subject matter of Examples 1-10 includes, wherein: the output text data comprises one or more tags generated according to a predefined taxonomy.

In Example 12, the subject matter of Examples 1-11 includes, wherein: the obtaining of the unmodified image and a modified image comprises: obtaining an unmodified video; obtaining a modified video comprising the unmodified video modified by the XR effect; applying an untrained convolutional neural network to a first sequence of frames of the unmodified video and a second sequence of corresponding frames of the modified video to generate embeddings of the first sequence of frames and the second sequence of corresponding frames; computing measurements of difference between the embeddings of each frame of the first sequence of frames and the corresponding frame of the second sequence of corresponding frames; and selecting an unmodified frame from the unmodified video as the unmodified image, and selecting a corresponding modified frame from the modified video as the modified image, based on the computed measurements of difference; the operations further comprise: processing textual metadata associated with the XR effect to generate XR effect label data; the applying of the trained multimodal generative language model to the unmodified image and the modified image comprises: providing the XR effect label data as a further input to the trained multimodal generative language model to generate the visual difference text; the additional text data comprises: the textual metadata; and visual text displayed as part of the XR effect; the obtaining of the additional text data comprises: performing optical character recognition on a frame of the modified video to generate the visual text, the visual text not being in a primary language for which the generative language model has been trained; and performing machine translation of the visual text to generate primary language visual text in the primary language; the output text data comprises: a caption; and one or more tags generated according to a predefined taxonomy; and the operations further comprise: applying a word encoder to the output text data to generate word embeddings of the output text data.

Example 13 is a method, comprising: obtaining an unmodified image and a modified image, the modified image comprising the unmodified image modified by an extended reality (XR) effect; applying a trained multimodal generative language model to the unmodified image and the modified image to generate visual difference text descriptive of visual differences between the modified image and the unmodified image; obtaining additional text data associated with the XR effect; and applying a trained generative language model to the visual difference text and the additional text data to generate output text data descriptive of the XR effect.

In Example 14, the subject matter of Example 13 includes, wherein: the obtaining of the unmodified image and a modified image comprises: processing a first sequence of frames of an unmodified video and a second sequence of corresponding frames of a modified video to generate a collage comprising the unmodified image and the modified image, the modified video comprising the unmodified video modified by the XR effect, the unmodified image and the modified image corresponding to an unmodified frame from the unmodified video and a corresponding modified frame from the modified video selected based on a measurement of difference between the unmodified frame and the corresponding modified frame.

In Example 15, the subject matter of Example 14 includes, wherein: the processing the sequence of frames of the unmodified video and the corresponding sequence of frames of the modified video comprises: applying an untrained convolutional neural network to the first sequence of frames and the second sequence of corresponding frames to generate embeddings of the first sequence of frames and the second sequence of corresponding frames; computing the measurement of difference between the embeddings of each frame of the first sequence of frames and each corresponding frame of the second sequence of corresponding frames; and selecting the unmodified frame and the modified frame based on the computed measurement of difference.

In Example 16, the subject matter of Examples 13-15 includes, wherein: the method further comprises: processing textual metadata associated with the XR effect to generate XR effect label data; and the applying of the trained multimodal generative language model to the unmodified image and the modified image comprises: providing the XR effect label data as a further input to the trained multimodal generative language model to generate the visual difference text.

In Example 17, the subject matter of Examples 13-16 includes, wherein: the additional text data comprises visual text displayed as part of the XR effect; and the obtaining of the additional text data comprises: performing optical character recognition on a frame of a modified video to generate the visual text, the modified video comprising a video modified by the XR effect.

In Example 18, the subject matter of Example 17 includes, wherein: the visual text is not in a primary language for which the generative language model has been trained; and the generating of the visual text further comprises performing machine translation of the visual text to generate primary language visual text in the primary language.

In Example 19, the subject matter of Examples 1-18 includes, wherein: the operations further comprise: applying a word encoder to the output text data to generate word embeddings of the output text data.

Example 20 is a non-transitory computer-readable storage medium, the computer-readable storage medium including instructions that when executed by a processor of a system, cause the system to perform operations comprising: obtaining an unmodified image and a modified image, the modified image comprising the unmodified image modified by an extended reality (XR) effect; applying a trained multimodal generative language model to the unmodified image and the modified image to generate visual difference text descriptive of visual differences between the modified image and the unmodified image; obtaining additional text data associated with the XR effect; and applying a trained generative language model to the visual difference text and the additional text data to generate output text data descriptive of the XR effect.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

Other technical features may be readily apparent to one skilled in the art from the following figures, descriptions, and claims.

### Glossary

“Augmented reality” (AR) or “extended reality” (XR) refer, for example, to an interactive experience of a real-world environment where physical objects that reside in the real-world are “augmented” or enhanced by computer-generated digital content (also referred to as AR effects, XR effects, virtual content, virtual objects, or synthetic content). AR or XR can also refer to a system that enables a combination of real and virtual worlds, real-time interaction, and 3D registration of virtual and real objects. A user of an AR or XR system perceives virtual content that appear to be attached or interact with a real-world physical object.

“Client device” refers, for example, to any machine that interfaces to a communications network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

“Communication network” refers, for example, to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network, and the coupling may be a Code Division Multiple Access (CDMA) connection, a Global System for Mobile communications (GSM) connection, or other types of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth-generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

“Component” refers, for example, to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor or other programmable processors. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

“Computer-readable storage medium” refers, for example, to both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Machine storage medium” refers, for example, to a single or multiple storage devices and media (e.g., a centralized or distributed database, and associated caches and servers) that store executable instructions, routines and data. The term shall accordingly be taken to include, but not be limited to, solid-state memories, and optical and magnetic media, including memory internal or external to processors. Specific examples of machine-storage media, computer-storage media and device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Non-transitory computer-readable storage medium” refers, for example, to a tangible medium that is capable of storing, encoding, or carrying the instructions for execution by a machine.

“Signal medium” refers, for example, to any intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

“User device” refers, for example, to a device accessed, controlled or owned by a user and with which the user interacts perform an action, or an interaction with other users or computer systems.

What is claimed is:

1. A system comprising:
at least one processor; and
a memory storing instructions that, when executed by the at least one processor, configure the system to perform operations comprising:
obtaining an unmodified image and a modified image, the modified image comprising the unmodified image modified by an extended reality (XR) effect;
applying a trained multimodal generative language model to the unmodified image and the modified image to generate visual difference text descriptive of visual differences between the modified image and the unmodified image;
obtaining additional text data associated with the XR effect; and
applying a trained generative language model to the visual difference text and the additional text data to generate output text data descriptive of the XR effect.

2. The system of claim 1, wherein:
the obtaining of the unmodified image and the modified image comprises:
processing a first sequence of frames of an unmodified video and a second sequence of corresponding frames of a modified video to generate a collage comprising the unmodified image and the modified image,
the modified video comprising the unmodified video modified by the XR effect,
the unmodified image and the modified image corresponding to an unmodified frame from the unmodified video and a corresponding modified frame from the modified video selected based on a measurement of difference between the unmodified frame and the corresponding modified frame.

3. The system of claim 2, wherein:
the processing of the sequence of frames of the unmodified video and the corresponding sequence of frames of the modified video comprises:
applying an untrained convolutional neural network to the first sequence of frames and the second sequence of corresponding frames to generate embeddings of the first sequence of frames and the second sequence of corresponding frames;
computing the measurement of difference between the embeddings of each frame of the first sequence of frames and each corresponding frame of the second sequence of corresponding frames; and
selecting the unmodified frame and the modified frame based on the computed measurement of difference.

4. The system of claim 1, wherein:
the operations further comprise:
processing textual metadata associated with the XR effect to generate XR effect label data; and
the applying of the trained multimodal generative language model to the unmodified image and the modified image comprises:
providing the XR effect label data as a further input to the trained multimodal generative language model to generate the visual difference text.

5. The system of claim 1, wherein:
the additional text data comprises textual metadata associated with the XR effect.

6. The system of claim 1, wherein:
the additional text data comprises visual text displayed as part of the XR effect.

7. The system of claim 6, wherein:
the obtaining of the additional text data comprises:
performing optical character recognition on a frame of a modified video to generate the visual text, the modified video comprising a video modified by the XR effect.

8. The system of claim 7, wherein:
the visual text is not in a primary language for which the generative language model has been trained; and
the generating of the visual text further comprises performing machine translation of the visual text to generate primary language visual text in the primary language.

9. The system of claim 1, wherein:
the operations further comprise:
applying a word encoder to the output text data to generate word embeddings of the output text data.

10. The system of claim 1, wherein:
the output text data comprises a caption.

11. The system of claim 1, wherein:
the output text data comprises one or more tags generated according to a predefined taxonomy.

12. The system of claim 1, wherein:
the obtaining of the unmodified image and the modified image comprises:
obtaining an unmodified video;
obtaining a modified video comprising the unmodified video modified by the XR effect;
applying an untrained convolutional neural network to a first sequence of frames of the unmodified video and a second sequence of corresponding frames of the modified video to generate embeddings of the first sequence of frames and the second sequence of corresponding frames;
computing measurements of difference between the embeddings of each frame of the first sequence of frames and the corresponding frame of the second sequence of corresponding frames; and
selecting an unmodified frame from the unmodified video as the unmodified image, and selecting a corresponding modified frame from the modified video as the modified image, based on the computed measurements of difference;
the operations further comprise:
processing textual metadata associated with the XR effect to generate XR effect label data;
the applying of the trained multimodal generative language model to the unmodified image and the modified image comprises:
providing the XR effect label data as a further input to the trained multimodal generative language model to generate the visual difference text;
the additional text data comprises:
the textual metadata; and
visual text displayed as part of the XR effect;
the obtaining of the additional text data comprises:
performing optical character recognition on a frame of the modified video to generate the visual text, the visual text not being in a primary language for which the generative language model has been trained; and
performing machine translation of the visual text to generate primary language visual text in the primary language;
the output text data comprises:
a caption; and
one or more tags generated according to a predefined taxonomy; and
the operations further comprise:
applying a word encoder to the output text data to generate word embeddings of the output text data.

13. A method, comprising:
obtaining an unmodified image and a modified image, the modified image comprising the unmodified image modified by an extended reality (XR) effect;
applying a trained multimodal generative language model to the unmodified image and the modified image to generate visual difference text descriptive of visual differences between the modified image and the unmodified image;
obtaining additional text data associated with the XR effect; and
applying a trained generative language model to the visual difference text and the additional text data to generate output text data descriptive of the XR effect.

14. The method of claim 13, wherein:
the obtaining of the unmodified image and the modified image comprises:
processing a first sequence of frames of an unmodified video and a second sequence of corresponding frames of a modified video to generate a collage comprising the unmodified image and the modified image,
the modified video comprising the unmodified video modified by the XR effect,
the unmodified image and the modified image corresponding to an unmodified frame from the unmodified video and a corresponding modified frame from the modified video selected based on a measurement of difference between the unmodified frame and the corresponding modified frame.

15. The method of claim 14, wherein:
the processing of the sequence of frames of the unmodified video and the corresponding sequence of frames of the modified video comprises:
applying an untrained convolutional neural network to the first sequence of frames and the second sequence of corresponding frames to generate embeddings of the first sequence of frames and the second sequence of corresponding frames;
computing the measurement of difference between the embeddings of each frame of the first sequence of frames and each corresponding frame of the second sequence of corresponding frames; and
selecting the unmodified frame and the modified frame based on the computed measurement of difference.

16. The method of claim 13, wherein:
the method further comprises:
processing textual metadata associated with the XR effect to generate XR effect label data; and
the applying of the trained multimodal generative language model to the unmodified image and the modified image comprises:
providing the XR effect label data as a further input to the trained multimodal generative language model to generate the visual difference text.

17. The method of claim 13, wherein:
the additional text data comprises visual text displayed as part of the XR effect; and
the obtaining of the additional text data comprises:
performing optical character recognition on a frame of a modified video to generate the visual text, the modified video comprising a video modified by the XR effect.

18. The method of claim 17, wherein:
the visual text is not in a primary language for which the generative language model has been trained; and
the generating of the visual text further comprises performing machine translation of the visual text to generate primary language visual text in the primary language.

19. The method of claim 13, wherein:
the method further comprises:
applying a word encoder to the output text data to generate word embeddings of the output text data.

20. A non-transitory computer-readable storage medium, the computer-readable storage medium including instructions that when executed by a processor of a system, cause the system to perform operations comprising:
obtaining an unmodified image and a modified image, the modified image comprising the unmodified image modified by an extended reality (XR) effect;
applying a trained multimodal generative language model to the unmodified image and the modified image to generate visual difference text descriptive of visual differences between the modified image and the unmodified image;
obtaining additional text data associated with the XR effect; and
applying a trained generative language model to the visual difference text and the additional text data to generate output text data descriptive of the XR effect.
